(19) United States
(12) Patent Application Publication
(10) Pub. No.: US 2009/0224624 A1
(43) Pub. Date: Sep. 10, 2009

(54) ROTOR STRUCTURE FOR INTERIOR PERMANENT MAGNET ELECTROMOTIVE MACHINE

(76) Inventors: AJITH KUTTANNAIR KUMAR, Erie, PA (US); Ramasamy Anbarasu, Salem (IN); Anshuman Tripathi, Allahabad (IN); Arvind Kumar Tiwari, Bangalore (IN); Roy David Schultz, Erie, PA (US); Patrick Lee Jansen, Scotia, NY (US); Rammohan Rao Kalluri, Kandukur (IN); Shishir Chandrasekhar Menon, Bangalore (IN)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 12/396,822

(22) Filed: Mar. 3, 2009

Related U.S. Application Data
(60) Provisional application No. 61/034,348, filed on Mar. 6, 2008.

(51) Int. Cl. H02K 1/27

(52) U.S. Cl. 310/156.53; 310/156.57

(57) ABSTRACT

A rotor structure for an interior permanent magnet (IPM) electromotive machine is provided. The rotor structure includes at least one rotor lamination including a first group of slots and a second group of slots arranged to form a magnetic pole. The first group of slots may be arranged to form a magnetic flux along a direct axis of the magnetic pole resulting from the first and second group of slots. At least some of the first group of slots is arranged to receive a respective permanent magnet. The second group of slots is arranged to provide a separation for the magnetic flux from adjacent magnetic poles and lying along a quadrature axis of said magnetic pole. At least some of the second group of slots is arranged without a permanent magnet. The rotor structure further includes a magneto-mechanical barrier arranged to reduce a peak level of mechanical stress occurring by the first and/or the second group of slots and/or impede a flow of magnetic flux through the barrier.

This application claims the benefit of U.S. Provisional Patent Application Ser. No. 61/034,348 filed on Mar. 6, 2008, which is incorporated by reference herein in its entirety.

### FIELD OF THE INVENTION

The present invention is generally related to electromotive machines, and, more particularly, to rotor structures containing buried permanent magnets for relatively large electromotive machines.

### BACKGROUND OF THE INVENTION

Presently, direct current (DC) or induction electromotive machines are generally used in diesel/electric-based locomotives, in mining vehicles and other off-highway vehicles, in certain marine vessels, and in stationary applications (e.g., for drilling purposes). The machines may be used in various operational contexts, including traction, auxiliary equipment, such as blowers or cooling equipment, and electrical power generating equipment.

Although these machines have proven through the years to be the workhorses of the industry, they sometimes suffer from various drawbacks. For example, in the case of traction motors, such motors tend to be relatively heavy, and inefficient in terms of electro-mechanical energy conversion. The capability of these machines is important not only from a fuel savings point of view but also from size, weight, cost, transient capability, cooling system, failure rate, etc. Moreover, any incremental weight of the traction motors tends to increase the transient forces on the truck (in a rail vehicle) and the road/track.

In the case of power generating equipment, DC or induction electromotive machines are typically in the form of a salient pole synchronous generator. Such generators commonly use an exciter winding in the rotor and may be energized through slip rings. The slips rings are subject to electro-mechanical wear and tear and may need burdensome and costly maintenance. Moreover, the volumetric spacing for vehicular applications (e.g., a locomotive) may have to be increased to accommodate the spacing requirements of electrical generating systems that use slip rings and exciter windings. In view of the foregoing considerations, it is desirable to provide an improved electromotive machine that avoids or reduces the drawbacks discussed above.

### BRIEF DESCRIPTION OF THE INVENTION

In one aspect thereof, the present invention is directed to a rotor structure for an interior permanent magnet (IPM) electromotive machine. The rotor structure includes at least one rotor lamination including a first group of slots and a second group of slots arranged to form a magnetic pole. The first group of slots may be arranged to form a magnetic flux along a direct axis of the magnetic pole resulting from the first and second group of slots. At least some of the first group of slots is arranged to receive a respective permanent magnet. The second group of slots is arranged to provide a separation for the magnetic flux from adjacent magnetic poles and lying along a quadrature axis of said magnetic pole. At least some of the second group of slots is arranged without a permanent magnet. The rotor structure further includes a magneto-mechanical barrier arranged to reduce a peak level of mechanical stress occurring by the first and/or the second group of slots and/or impede a flow of magnetic flux through the barrier. In one example embodiment, the magneto-mechanical barrier includes at least a cutout disposed at an outer edge of the rotor lamination. The cutout is aligned to correspond with the magnetic flux along the direct axis to reduce a back-EMF voltage when the machine operates at a predefined speed.

### BRIEF DESCRIPTION OF THE DRAWINGS

FIG. 1 is an isometric view of an example embodiment of a rotor structure embodying aspects of the present invention for a hybrid interior permanent magnet (IPM) electromotive machine.

FIG. 2 is an isometric view of another example embodiment of a rotor structure embodying aspects of the present invention.

### DETAILED DESCRIPTION OF THE INVENTION

A hybrid interior permanent magnet (IPM) electromotive machine 8 embodying aspects of the present invention uses an improved rotor structure 10 with enhanced electromagnetic and/or mechanical characteristics. As a result of such enhancements, a rotor structure embodying aspects of the present invention may be advantageously used in relatively large electromotive machines of high power rating in applications that may require operating under a limited input voltage over a broad range of speeds including operation at high speeds, such as typical of locomotives, mining vehicles and other off-highway vehicles (OHV), marine vessels, and stationary applications (e.g., for drilling purposes).

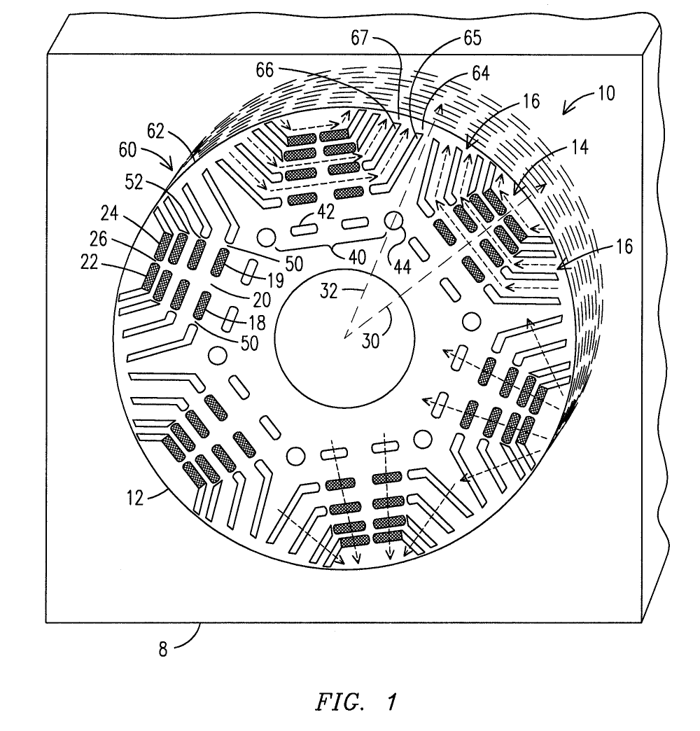

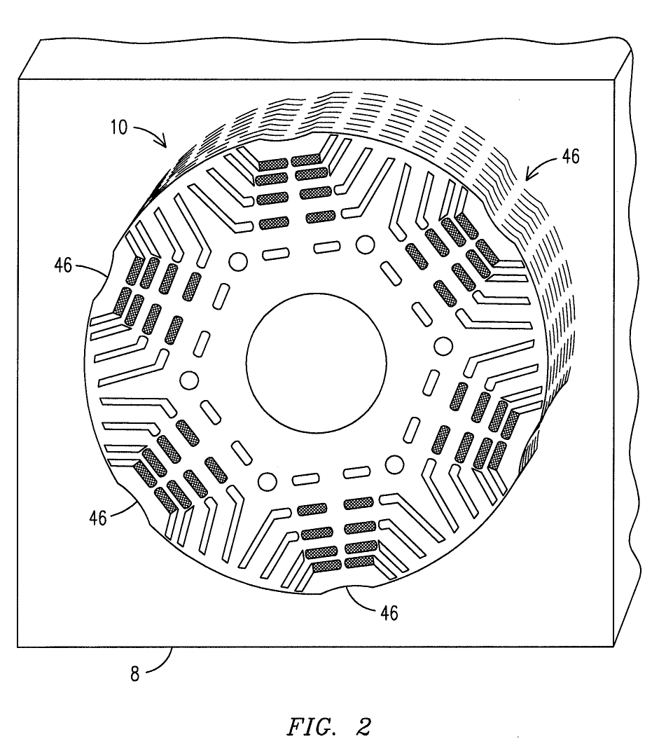

Rotor structure 10 includes at least one rotor lamination 12 that includes a first group of slots 14 and a second group of slots 16 arranged to form a magnetic pole. (As described in more detail below, “lamination” refers to a thin metal plate or other thin plate, a plurality of which are typically stacked and adhered together to form a motor component. Thus, when it is characterized herein that the lamination includes or comprises various slots, openings, cutouts, etc., this means that the lamination is formed to define the slots, openings, cutouts, etc. through machining, cutting, stamping, or otherwise.) FIGS. 1 and 2 respectively show a number of first and second groups of slots that in combination form an example six-pole machine. It will be appreciated that aspects of the present invention are not limited to any specific number of poles. As the description proceeds below, the reader is advised that for the sake of avoiding visual cluttering, counterpart elements of different magnetic poles may be pointed to in the drawings since the functionality of such counterpart elements is the same in any given pole of the machine.

In one example embodiment, each of the first group of slots 14 may be made up of a pair of slots, such as slot pair 18 and 19 that extends from a respective center post 20. Each pair of slots that extends from a respective center post may be perpendicularly positioned relative to a direct axis 30, that is, the pair of slots together define an axis that is perpendicular to the direct axis 30.

In one example embodiment, the center posts may be designed with a radially graded arrangement, that is, the center posts are progressively structured differently from one another based on radial position. For example, a center post (e.g., center post 20) of a pair of slots (e.g., slots 18 and 19) located radially inwardly relative to another pair of slots (e.g., slots 22 and 24) is made up of a larger structure compared to the structure of the center post 26 of slots 22 and 24. In one embodiment, “larger structure” is determined based on the lengths of the center posts between their respective associated slots. For example, as defined by the shortest distance between slots 18 and 19 versus the shortest distance between slots 22 and 24, the center post 20 is longer than the center post 26.

The first group of slots 14 may be arranged to form a magnetic flux generally along direct axis 30, which represents the direct axis of the magnetic pole resulting from the first and second groups of slots. At least some of the first group of slots are arranged to receive a respective permanent magnet. In one example embodiment, each of the first group of slots 14 includes a permanent magnet (i.e., for each slot the permanent magnet is disposed in the slot), as represented by the slots filled with cross-hatching.

The second group of slots 16 is arranged to provide a separation for the magnetic flux from adjacent magnetic poles and lies generally along a quadrature axis 32 of the magnetic pole. At least some of the second group of slots may be arranged without a respective permanent magnet. In one example embodiment, each of the second group of slots 16 is without a permanent magnet, as represented by the slots without cross-hatching. This arrangement results in a magnetic field weakening sufficient to allow an increase of rotor speed at a constant power in a range from a base speed to a top speed (e.g., 4500 RPM). In one example embodiment, a ratio of the top speed to the base speed can be up to a value of about 10. It is contemplated that in accordance with the ordinary meaning of the expression “up to” in the context of numerical limits, the endpoint (e.g., a value of 10) is expressly included.

At least some of the second group of slots 16 extend from a respective transition post (e.g., transition post 50) configured to mechanically transition from the first group of slots to the second group of slots. That is, each transition post provides a structural member between one of the first group of slots and an adjacent one of the second group of slots, to buttress against expected mechanical forces. The transition posts may also be designed with a radially graded arrangement. For example, a transition post located radially inwardly (e.g., transition post 50) relative to another transition post (e.g., transition post 52) comprises a larger structure compared to the structure of transition post 52. Again, “larger structure” may be determined based on the relative lengths of the transition posts between their respective slots. Each slot that extends from a respective transition post may include a section slantingly extending relative to a radius passing through a corresponding opening (e.g., opening 44) located along the path of the magnetic flux along the quadrature axis.

In one example embodiment, each of the second group of slots 16 extends up to a respective bridge region 60 that define a plurality of bridges neighboring an outer edge 62 of the lamination. The bridges may be designed to include a radially graded arrangement. For example, a bridge 64 for a slot (e.g., slot 65) originating from a radially inwardly location relative to the originating location of another slot (e.g., slot 66) comprises a larger structure compared to the structure of a bridge 67 of slot 66. As above, “larger structure” may be determined based on the length of each bridge, as extending between the end of the nearest slot and the outer edge of the lamination.

It will be appreciated that the sizing of the above-described center post structures, transition post structures, and/or bridge structures is selected to balance counter-opposing magnetic and mechanical constraints. For example, from a magnetic point of view, one would like a sufficiently narrow interconnecting structure to reduce flux losses. However, from a mechanical point of view, one would like sufficiently wide interconnecting structures to withstand an expected level of mechanical stress.

Rotor structure 10 further includes a magneto-mechanical barrier 40, such as may be arranged to reduce a peak level of mechanical stress occurring by the first and/or the second group of slots and/or impede a flow of magnetic flux through the barrier. In one example embodiment, magneto-mechanical barrier 40 includes at least one hollow slot 42 positioned by the first group of slots 14 and located radially inwardly relative to the first group of slots. It will be appreciated that the magnetic flux impeding aspect of magneto-mechanical barrier 40 allows increasing the saliency ratio of the machine. In one example embodiment, the mechanical stress barrier further includes at least one opening 44 located along the quadrature axis.

In another example embodiment, as illustrated in FIG. 2, the magneto-mechanical barrier further includes cutouts 46 disposed at the outer edge of the rotor lamination. Each cutout is aligned to correspond with the magnetic flux along the direct axis to reduce a back-EMF voltage when the machine operates at a predefined speed.

In one example embodiment, the presence of the direct axis cutouts 46 (e.g., 7.5 mm depth) allowed the top speed voltage requirement to be reduced by approximately 11%. Moreover, the combination of features illustrated in FIG. 2 resulted in peak mechanical stresses being reduced by approximately 10-12% (e.g., @4500 RPM, and 100 micron interference fit). The top speed RPM capability was improved by approximately 5-6% (e.g., from 4250 to 4500 RPM). The developed torque capability was improved by approximately 5%. The diameter of the rotor structure was reduced by approximately 2.5% (or the length reduced by approximately by 5%) with a weight reduction of about 5%.

It is contemplated that the mechanical stress reduction and/or magnetic flux reduction (e.g., provided by slots 42, openings 44, and/or cutouts 46) result in a relatively tighter interference tolerance between shaft and the rotor lamination. Additionally, such features may be adapted for providing optional rotor cooling ducts.

It will be appreciated that torque production in hybrid machine 8 is made up of two components: 1) a torque contribution due to the permanent magnets; and 2) a torque contribution due to reluctance effects, such as results from an interaction of magnetic flux directed by the arrangement of slots and flux produced by currents that flow in the stator windings (not shown).

It will be further appreciated that a ratio of reluctance torque (i.e., torque produced due to slotting effects) to permanent magnet torque (i.e., torque produced by the interaction of permanent magnet field and the field produced by stator current) can be varied by appropriately designing the configuration, interspacing, and/or number of slots and/or magnet arrangement (e.g., number of magnets, magnet strength). A higher ratio of reluctance torque to permanent magnet torque may be desirable since the cost of the traction motor will be relatively lower. Additionally, the traction motor can be operated even if the permanent magnets become demagnetized due to unforeseen circumstances (e.g., when the temperature of the magnet is higher than the Curie temperature of the magnets). In one example embodiment, an IPM machine with a reluctance-to-permanent magnet ratio of approximately 80:20 has been successfully designed and tested. It will be appreciated that this ratio represents just an example, as different ratios are possible and a given ratio value may be selected based on the needs of any given machine application.

As can be appreciated from the isometric views of FIGS. 1 and 2, rotor structure 10 may be formed from a stack of laminations, such as may be made of a suitable ferromagnetic material, such as may have low loss and high mechanical strength suitable for substantially high rotational speeds. Each lamination may be constructed using mechanical manufacturing techniques well-understood by those skilled in the art, such as punching performed on a ferromagnetic metal sheet or casting of ferromagnetic material. In larger rotor diameter machines (such as low speed high power IPM generators), the posts may be made of non-magnetic material that in turn: a) reduces the magnetic leakage flux; b) reduces magnet volume; and c) increases reluctance torque for a give rating of the machine.

Selection of the slot position for the magnets and magnet volume may be based on a number of considerations not necessarily limited to the following considerations: a) no load voltage under transient condition; b) fault current levels; c) field weakening speed range desired in case of motor application; d) efficiency desired for motoring and generating operations; and e) a flat output voltage-current characteristics up to desired power out level for a given operating speed in case of generator mode.

In operation, when used as a traction motor, an IPM machine embodying aspects of the present invention may provide various example advantages. For example, such a machine may provide a higher amount of torque per a given amount of volume, may improve thermal and transient performance, may be cost effectively used for retrofit applications, such as by replacing a so-called squirrel cage rotor without modifying any other system components in a pre-existing locomotive. For example, a rotor embodying aspects of the present invention may be retrofitable into an existing AC traction motor stator.

In operation, when used as part of auxiliary equipment, an IPM machine embodying aspects of the present invention may provide various example advantages. For example, may improve auxiliary equipment performance in terms of efficiency & size. Example applications may be cooling air pump, radiator, grid resistor cooling fan motors.

In operation, when used as a generator, an IPM machine embodying aspects of the present invention may provide various example advantages. For example, may be retrofittable into an existing generator stator or modified stator slots and winding pattern (e.g., concentric, tooth or customized winding pattern) with a hybrid IPM rotor configured to meet required voltage, current, power output and performance.

Another embodiment relates to an electromotive machine. The electromotive machine comprises a stator and a rotor operably coupled to the stator, e.g., for rotation of the rotor relative to the stator. The rotor comprises a plurality of stacked rotor laminations, each of which is configured according to one of the embodiments described above.

While various embodiments of the present invention have been shown and described herein, it will be understood that such embodiments are provided by way of example only. Numerous variations, changes and substitutions may be made without departing from the invention herein. Accordingly, it is intended that the invention be limited only by the spirit and scope of the appended claims.

What is claimed is:

1. A rotor structure for an interior permanent magnet electromotive machine, said rotor structure comprising:
at least one rotor lamination comprising:
a first group of slots and a second group of slots arranged to form a magnetic pole, the first group of slots arranged to form a magnetic flux along a direct axis of the magnetic pole resulting from the first and second group of slots, at least some of the first group of slots arranged to receive a respective permanent magnet, the second group of slots arranged to provide a separation for the magnetic flux from adjacent magnetic poles and lying along a quadrature axis of said magnetic pole, at least some of the second group of slots arranged without a permanent magnet; and
a magneto-mechanical barrier arranged to reduce a peak level of mechanical stress occurring by the first and/or the second group of slots and/or impede a flow of magnetic flux there through.

2. The rotor structure of claim 1, wherein the magneto-mechanical barrier comprises at least one hollow slot positioned by the first group of slots and located radially inwardly relative to said first group of slots.

3. The rotor structure of claim 2, wherein the magneto-mechanical barrier further comprises at least one opening located along the quadrature axis.

4. The rotor structure of claim 1, wherein the magneto-mechanical barrier further comprises at least a cutout disposed at an outer edge of said rotor lamination, the cutout aligned to correspond with the magnetic flux along the direct axis to reduce a back-EMF voltage when the machine operates at a predefined speed.

5. The rotor structure of claim 1, wherein each of the second group of slots comprises a slot without a permanent magnet.

6. The rotor structure of claim 1, wherein each of the first group of slots comprises a slot with a permanent magnet.

7. The rotor structure of claim 1, wherein each of said first group of slots comprises a pair of slots extending from a respective center post, wherein the center posts in said first group of slots are in a radially graded arrangement, wherein a center post of a pair of slots located radially inwardly relative to a center post of another pair of slots comprises a larger structure compared to the structure of the center post of said another pair of slots.

8. The rotor structure of claim 7, wherein each pair of slots extending from a respective center post is perpendicularly positioned relative to the direct axis.

9. The rotor structure of claim 1, wherein at least some of said second group of slots comprise a slot extending from a respective transition post, the transition post configured to mechanically transition from the first group of slots to the second group of slots, wherein the transition posts are in a radially graded arrangement, wherein a transition post located radially inwardly relative to another transition post comprises a larger structure compared to the structure of said another transition post.

10. The rotor structure of claim 9, wherein each slot extending from a respective transition post comprises a section slantingly extending relative to a radius passing through said at least one opening located along the path of the magnetic flux along the quadrature axis.

11. The rotor structure of claim 10, wherein each of said second group of slots extends to a respective bridge region neighboring an outer edge of the lamination, wherein a plurality of bridges in the bridge region are in a radially graded arrangement, wherein a bridge for a slot originating from a radially inwardly location relative to an originating location of another slot comprises a larger structure compared to the structure of the bridge of said another slot.

12. The rotor structure of claim 1, wherein a separation between adjacent slots of said second group of slots varies as a function of the radial distance from an axis of rotation of the rotor.

13. The rotor structure of claim 5, wherein a magnetic field weakening resulting from the second group of slots being arranged without a permanent magnet is sufficient to allow an increase of rotor speed at a constant power in a range from a base speed to a top speed, wherein a ratio of the top speed to the base speed is up to a value of about 10.

14. A rotor structure for an interior permanent magnet electromotive machine, said rotor structure comprising:
at least one rotor lamination comprising:
a first group of slots and a second group of slots arranged to form a magnetic pole, the first group of slots arranged to form a magnetic flux along a direct axis of the magnetic pole resulting from the first and second group of slots, at least some of the first group of slots arranged to receive a respective permanent magnet, the second group of slots arranged to provide a separation for the magnetic flux from adjacent magnetic poles and lying along a quadrature axis of said magnetic pole, at least some of the second group of slots arranged without a permanent magnet; and
a magneto-mechanical barrier arranged to reduce a peak level of mechanical stress occurring by the first and/or the second group of slots and/or impede a flow of magnetic flux there through, wherein the magneto-mechanical barrier comprises at least one hollow slot positioned by the first group of slots and located radially inwardly relative to said first group of slots, at least one opening located along a path of the magnetic flux along the quadrature axis, and/or at least a cutout disposed at an outer edge of said rotor lamination, the cutout aligned to correspond with the magnetic flux along the direct axis to reduce a back-EMF voltage when the machine operates at a predefined speed.

15. The rotor structure of claim 14, wherein each of the second group of slots comprises a slot without a permanent magnet.

16. The rotor structure of claim 14, wherein each of the first group of slots comprises a slot with a permanent magnet.

17. The rotor structure of claim 14, wherein each of said first group of slots comprises a pair of slots extending from a respective center post, wherein the center posts in said first group of slots are in a radially graded arrangement, wherein a center post of a pair of slots located radially inwardly relative to a center post of another pair of slots comprises a larger structure compared to the structure of the center post of said another pair of slots.

18. The rotor structure of claim 17, wherein each pair of slots extending from a respective center post is perpendicularly positioned relative to the direct axis.

19. The rotor structure of claim 14, wherein at least some of said second group of slots comprise a slot extending from a respective transition post, the transition post configured to mechanically transition from the first group of slots to the second group of slots, wherein the transition posts are in a radially graded arrangement, wherein a transition post located radially inwardly relative to another transition post comprises a larger structure compared to the structure of said another transition post.

20. The rotor structure of claim 19, wherein each slot extending from a respective transition post comprises a section slantingly extending relative to a radius passing through said at least one opening located along the path of the magnetic flux along the quadrature axis.

21. The rotor structure of claim 20, wherein each of said second group of slots extends to a respective bridge region neighboring an outer edge of the lamination, wherein a plurality of bridges in the bridge region are in a radially graded arrangement, wherein a bridge for a slot originating from a radially inward location relative to an originating location of another slot comprises a larger structure compared to the structure of a bridge of said another slot.

22. The rotor structure of claim 14, wherein a separation between adjacent slots of said second group of slots varies as a function of the radial distance from an axis of rotation of the rotor.

23. The rotor structure of claim 15, wherein a magnetic field weakening resulting from the second group of slots being arranged without a permanent magnet is sufficient to allow an increase of rotor speed at a constant power in a range from a base speed to a top speed, wherein a ratio of the top speed to the base speed can be up to a value of 10.

24. An electromotive machine comprising:
a stator; and
a rotor operably coupled to the stator, the rotor having a plurality of stacked rotor laminations each comprising:
a first group of slots and a second group of slots arranged to form a magnetic pole, the first group of slots arranged to form a magnetic flux along a direct axis of the magnetic pole resulting from the first and second group of slots, at least some of the first group of slots having a respective permanent magnet received therein, the second group of slots arranged to provide a separation for the magnetic flux from adjacent magnetic poles and lying along a quadrature axis of said magnetic pole, at least some of the second group of slots arranged without a permanent magnet; and
a magneto-mechanical barrier arranged to reduce a peak level of mechanical stress occurring by the first and/or the second group of slots and/or impede a flow of magnetic flux there through.
